(19) United States
(12) Patent Application Publication
(10) Pub. No.: US 2013/0124053 A1
(43) Pub. Date: May 16, 2013

(54) VEHICLE SAFETY SYSTEM AND METHOD WITH SPLIT ACTIVE/PASSIVE PROCESSING

(71) Applicant: Volvo Car Corporation, Goteborg (SE)

(72) Inventors: Peter Sandstroem, Goeteborg (SE); Erik Israelsson, Goeteborg (SE)

(73) Assignee: VOLVO CAR CORPORATION, Goteborg (SE)

(21) Appl. No.: 13/672,270

(22) Filed: Nov. 8, 2012

(30) Foreign Application Priority Data
Nov. 11, 2011 (EP) 11188791.5

(51) Int. Cl. B60R 21/0134

(52) U.S. Cl. CPC B60R 21/0134
USPC 701/46; 701/45

(57) ABSTRACT

A vehicle safety system includes a remote sensor detecting an object and a collision detector detecting a collision with the vehicle. An active safety module receives the remote sensor output and controls operation of an active vehicle safety system utilizing a first parameter set providing a first balance between suppression of false positive detections of imminent collision and acknowledgement of true positive detections of imminent collision, the first balance optimized for control of the active safety system. A passive safety module is connected in parallel with the active safety module to receive the sensor output and receives the detector output. The passive safety module utilizes a second parameter set to control operation of a passive vehicle safety system providing a second balance having, in relation to the first balance, a relatively lower suppression of false positive detections and a relatively higher acknowledgement of true positive detections.

### CROSS-REFERENCE TO RELATED APPLICATIONS

This application claims foreign priority benefits under 35 U.S.C. §119(a)-(d) to EP 11188791.5, filed Nov. 11, 2011, the disclosure of which is incorporated in its entirety by reference herein.

### TECHNICAL FIELD

The present invention relates to safety systems for motor vehicles and to a system and method for optimum operation of active and passive safety systems.

### BACKGROUND

Automotive safety systems are often divided into active (preventive) safety systems and passive (protective) safety systems respectively. Whereas the purpose of the passive safety systems is to mitigate injuries caused by an accident, the primary purpose of the active safety systems is to avoid accidents or to mitigate the consequences thereof.

A good understanding of the traffic situation around a vehicle is more or less a necessity in order to achieve efficient safety systems, particularly active safety systems. Radar sensing technology (possibly in combination with camera vision technology) is a widely used technique for detecting and tracking other objects around a vehicle and to estimate properties of the objects such as position and relative speed.

Active and passive safety applications usually imply different requirements on the sensors and the associated detection and tracking algorithms such as what types of object to detect, which scenarios and dynamic maneuvers to manage and the acceptable levels of false alarm rate, as well as the required availability and capability to detect true objects.

As already mentioned, radar sensors are commonly used as principal sensor in active safety systems. For passive safety applications, designed to be activated when a detection means in the form of a collision sensor, e.g. an accelerometer, has detected a collision event, input data from a radar sensor can be used to optimize the function execution, e.g. an adaptation of airbag force to the measured relative speed (by radar) just prior to the collision detection (by accelerometer). However, an ideal radar sensor-supported managing (detecting and tracking) means is expected to be different for passive safety functions and active safety functions, i.e. a managing means supporting both passive safety functions and active safety functions would probably not be optimal.

Typically, managing means logic for active safety must balance suppression of (unwanted) false positive detections and acknowledgement of true positive detections. The obvious motive is that false positive detections must be kept low to avoid false warnings or false interventions. At the same time, the suppression must not cause incorrect rejection of true positive detections, since this could lead to missed warnings or missed interventions in cases where they should be issued.

Passive safety functions are assumed to be activated by a collision detector, e.g. an accelerometer. Therefore, a managing means optimized for passive safety may be allowed to have lower suppression of false positive detections, since no activation will be issued unless the collision sensor confirms a collision, i.e. no false positive detections will ever cause unwanted function activation assuming that the collision sensor is robust with a high confidence level. The benefit from lower suppression of false positive detections is a lowered risk of incorrect suppression of true positive detections, i.e. a more reliable detection of true positive detections.

### SUMMARY

In a first embodiment disclosed herein, a system for a vehicle comprises a remote sensor monitoring a road environment to detect an object and generate a sensor output indicative thereof, and a collision detector detecting a collision with the vehicle and generating a detector output indicative thereof. An active safety module receives the sensor output and utilizes a first set of parameters to control operation of an active safety system of the vehicle. The first set of parameters provides a first balance between suppression of false positive detections of imminent collision and acknowledgement of true positive detections of imminent collision, the first balance being optimized for control to the active safety system. A passive safety module is connected in parallel with the active safety module to receive the sensor output and further receives the detector output. The passive safety module utilizes a second set of parameters to control operation of a passive safety system of the vehicle in a manner providing a second balance having, in relation to the first balance, a relatively lower suppression of false positive detections of imminent collision and a relatively higher acknowledgement of true positive detections of imminent collision.

In another embodiment disclosed herein, the first set of parameters is adapted for optimum function of the active safety system and comprises at least one of a first sensor output threshold value, a first kinematic model, and a first parameter interval within which measurements of properties of the object are allowed. The second set of parameters is adapted for optimum function of the passive safety system and comprises at least one of a second sensor output threshold value, a second kinematic model, and a second parameter interval.

In another embodiment disclosed herein, the system further comprises a first calculating and control unit operative to (when the active safety module determines that a collision with the object is imminent such that activation of the active safety system is warranted) determine an extent of activation of the active safety system and provide a signal indicative thereof to the active safety system, and a second calculating and control unit operative to (when a collision with the object is imminent such that activation of the active safety system is warranted) determine an extent of activation of the passive safety system and provide a signal indicative thereof to the passive safety system.

In another disclosed embodiment, a method for improving operating safety of a vehicle comprises operating a remote sensor to monitor a road environment and generate a sensor output indicative of an object in the environment, and operating a collision detector to generate an output indicative of a collision with the vehicle. An active safety system of the vehicle is activated in response to the remote sensor output utilizing a first set of parameters adapted for optimum function of the active safety system, the first set of parameters comprising at least one of a first sensor output threshold value, a first kinematic model, and a first parameter interval within which measurements of properties of the object are allowed. A passive safety system of the vehicle is activated in response to the sensor output and the detector output utilizing a second set of parameters adapted for optimum function of the passive safety system, the second set of parameters comprising at least one of a second sensor output threshold value, a second kinematic model, and a second parameter interval.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a schematic block diagram of a simplified embodiment of a safety system as described hereinbelow.

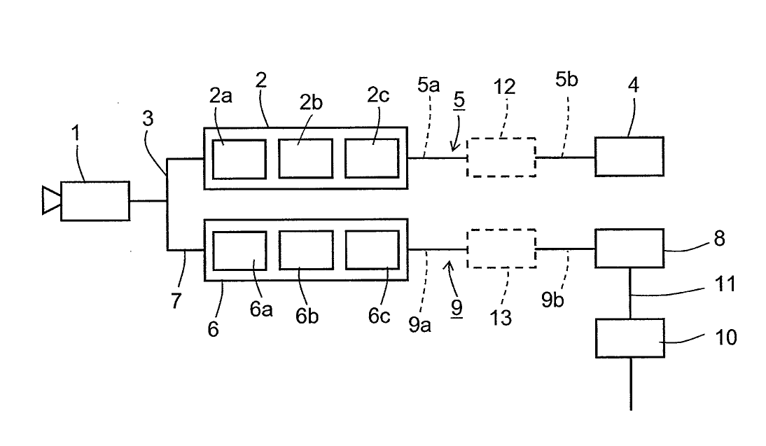

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The safety system illustrated in the drawing is provided in a vehicle for avoiding or mitigating a collision with other objects, such as e.g. cars, trucks, motorcycles, mopeds, bicycles, pedestrians etc. While, as mentioned, the safety system is illustrated by a block diagram, the vehicle is not shown in the drawing for reasons of clarity.

The safety system according to the invention comprises, in its most simple form, a remote sensor 1 operative to monitor a road environment in order to detect the relative approach of objects to the vehicle and provide an output signal indicative thereof. Sensor 1 may comprise one or more sensors of a suitable type, e.g. one or more sensors utilizing radio frequency radiation (radar), laser beams (lidar), optics, or any suitable combination of different sensors. The one or more remote sensors may generate low level sensor data (e.g. A/D-converted incoming radar echoes) to a number of safety controller modules which are connected in parallel (with regard to the output(s) of the remote sensor(s)) and which are individually adapted to support a set of safety functions that place similar requirements on types of objects, scenarios, probability of false alarm, etc.

The system further comprises an active safety module 2 which is operatively connected to the remote sensor 1. In the drawing, this connection is illustrated by means of a signal line 3, though the connection may also be wireless. The active safety module 2 is configured for activating, in response to the output from the remote sensor 1, one or more active safety systems of the vehicle. These active safety systems, illustrated in the drawing by a block 4, may include one or more of e.g. the anti-lock braking system (ABS), electronic stability system (ESP), active lane keeping system, active blind spot system, speed limit system, distance keeping systems, attention assist systems and other active safety arrangements as are well known in the art for avoiding or mitigating a collision with other objects. The active safety module 2 may be connected to the active safety system(s) 4 via a signal line 5, as in the drawing, or wirelessly.

The safety system also includes a passive safety module 6, which is operatively connected to the remote sensor 1, and in parallel (with regard to the remote sensor output) with the active safety module 2. The connection between the passive safety module 6 and the remote sensor 1 may be realized by means of a signal line 7 or wirelessly. The passive safety module 6 is configured for activating, in response to the output from the remote sensor 1, one or more passive safety systems of the vehicle. These passive safety systems, illustrated in the drawing by a block 8, may include one or more of e.g. airbags, seat belt tensioners, deployable bolsters, and/or other occupant restraint systems for mitigating the effects of a collision with another object. The passive safety module 6 may be connected to the passive safety system 8 via a signal line 9, as in the drawing, or wirelessly.

Since the active and passive safety modules 2, 6 are connected in parallel, the active and passive safety system 4, 8 may be activated independently from each other and one at the time or both simultaneously, depending on the first signal from the remote sensor 1. The parallel connection also allows said safety modules to be optimized differently for their respective applications.

As already mentioned above, the active and passive safety modules 2, 6 are configured for optimizing the function of the active and passive safety system 4, 8 respectively. That is, the active safety module 2 implements or utilizes a first set of parameters adapted to optimize the function of the active safety system(s) 4, while the passive safety module 6 implements or utilizes a second set of parameters designed to optimize the function of the passive safety system(s) 8. Accordingly, the active safety module 2 utilizes parameters designed to optimize the balance between suppression of false positive detections of an imminent collision and acknowledgement of true positive detections of an imminent collision. The passive safety module 6 utilizes parameters designed to provide, in comparison to the active safety module 2, a relatively lower suppression of false positive detections of an imminent collision and a relatively higher acknowledgement of true positive detections of an imminent collision.

The safety system also comprises a collision detector 10 which is configured for detecting a collision with another object and providing a second signal or detector output indicative thereof. The collision detector 10 may comprise at least one collision sensor, e.g. an accelerometer, or comprise one or more sensors of any other suitable type for the intended purpose. The collision detector 10 is operatively connected to the passive safety system 8 and configured for controlling, by means of the second signal, the activation of the passive safety system 8 of the vehicle. The collision detector 10 may be connected to the passive safety system 8 via a signal line 11 or wirelessly.

In order for the active and passive safety modules 2, 6 to optimize active and passive safety functions respectively, each of the safety modules 2, 6 may comprise a detection unit 2a, 6a. There is a detection theory which deals with the problem of detecting other objects in the presence of (internal and external) noise. An appropriate signal threshold is determined, above which noise seldom rises and below which signal plus noise seldom falls. The former case (when noise rises above the signal threshold) corresponds to a so-called false alarm. The latter case (when signal plus noise falls below the signal threshold) corresponds to a missed detection.

The probability of false alarm is a fundamental parameter for a sensing system. The “cost” (i.e. negative consequence) of a false alarm depends very much on what functionality is to be activated when a detected object is present. An audible warning due to an approaching object may allow for a relative large probability of false alarm (and thus, a low signal threshold), whereas an autonomous braking or steering intervention will only allow for a relatively small probability of false alarm (and thus, a high signal threshold). Functionalities such as audible warning and autonomous braking/steering intervention are examples of active safety systems. Examples of passive safety systems are systems that adapt or activate e.g. the airbag systems based on the presence of and information about other objects around the vehicle.

Since different functionality places different requirements on the probability of false alarm and also on what type of other objects to detect (a small object will seldom be detected with a high detection threshold), the detection threshold is an example of a parameter that can be individually adapted to type of functionality in each managing means 2, 6. Accordingly, the detection units 2a, 6a of the active and passive safety modules 2, 6 are individually configured with a threshold value for the first signal from the remote sensor, above which noise seldom rises and below which the first signal plus noise seldom falls.

In order for the active and passive safety modules 2, 6 to optimize active and passive safety functions respectively, the active and passive safety modules may also each comprise a tracking and estimating unit 2b, 6b. Tracking theory deals with the problem of keeping track of other objects which have been detected by, for example, the remote sensor 1. An often-used example of a tracking and estimating unit is the Kalman filter/estimator. The kinematic behaviour of an object may be described by a model. A simple model can be that all objects have a constant acceleration. In situations where the true object motion conforms well to the kinematic model, the estimate of parameters (position, speed, etc.) can become quite accurate. However, when the object manoeuvres in a way which does not conform well to the kinematic model, the filter will fail to follow the manoeuvre and the estimate may become inaccurate.

Since different functionalities are interested in different scenarios and types of object that may be present in the road environment, and because objects such as pedestrians and vehicles behave differently and therefore should be described by different kinematic models, the parameters of the kinematic models are examples of parameters which in each tracking and estimating unit 2b, 6b can be individually adapted to the type of functionality. Accordingly, the tracking and estimating units 2b, 6b of the active and passive safety modules 2, 6 are individually configured with parameters of kinematic models which are adapted to the active safety systems (4) and to the passive safety system(s) 8, respectively.

A still further function of the active and passive safety modules 2, 6 may involve the process of associating the measured properties of a true object that has been detected by the remote sensor 1 with a model object contained in a list thereof. If the measured properties (position and/or velocity, for example) of a detected true object differ very little from the properties of a model object contained in the list (as predicted by the kinematic model), the detection will be associated to that model object. The measurement parameter interval, within which measurements are allowed for being assigned to a certain model object, is called a gate. If the gates are very small, the probability of false alarm can be lowered at the cost of lower detection probability (or in other words robustness). The parameters defining gates are additional examples of parameters which, in each safety module 2, 6, can be individually adapted to the type of functionality. Accordingly, the active and passive safety modules 2, 6 may comprise associating units 2c, 6c. These associating units 2c, 6c are individually configured with a parameter interval within which measurements of properties of detected objects are allowed, and this parameter interval is adapted to the active safety system 4 and to the passive safety system 8, respectively.

As stated above, it is advantageous to have parallel individual managing means for activating safety functions which have different requirements on said managing means. This is advantageous since an autonomous brake intervention (for example) for an object approaching the vehicle only allows for a relatively small false alarm rate of the active safety module. Otherwise, it can be difficult for a driver to handle the effect of a false activation. The false alarm rate can be kept low e.g. by a suitable adaptation of the detection threshold and/or by a suitable choice of parameters for the kinematic model as mentioned above.

Another use of the output from a safety module is for the adaptation of triggering levels of pyrotechnic airbag systems. Airbag systems of today rely heavily on crash event detectors (accelerometers) which have a relatively high detection threshold. If the activation criteria of an airbag are conditioned on the detection of a collision, it follows that the protective or passive safety functions will be much less sensitive to false alarms from the managing means—the output from the managing means alone will not be a sufficient activation criteria (and whatever phenomenon which causes a false sensor system output is unlikely to trigger a false crash sensor event).

For the passive safety function above, adaptation of airbag systems, a more susceptive managing means for sensor data is made possible through the criteria of a detected crash event. Since that strategy is not available for the preventive or active safety function mentioned above (autonomous brake intervention), it is here an advantage to have two separate managing means connected in parallel—one managing means for the active safety function (with e.g. a relatively high detection threshold) and one for the passive safety function (with e.g. a relatively low detection threshold).

The safety system according to the invention may be supplemented by first and second calculating and control units 12, 13. In the illustrated embodiment, the first and second calculating and control units 12, 13 are shown as separate parts of the safety system according to the invention, connected between the active safety module 2 and the active safety system 4 and between the passive safety module 6 and the passive safety system 8 respectively. The first calculating and control unit 12 is configured for calculating (when a collision with an approaching object is determined to be imminent such that activation of the active safety system 4 is warranted) the extent of activation of the active safety system 4 and providing a fourth signal indicative thereof (via a second branch 5b of the signal line 5) to the active safety system 4. The fourth signal therefore instructs or controls the extent of activation of the active safety system.

The second calculating and control unit 13 is configured for calculating (when a collision with an approaching object is determined to be imminent such that activation of the passive safety system 8 is warranted) the extent of activation of the passive safety system and providing a sixth signal indicative thereof (via a second branch 9b of the signal line 9) to the passive safety system 8. The sixth signal therefore instructs or controls the extent of activation of the passive safety. As applied to the foregoing description of the first and second calculating and control units 12, 13 the term “extent of activation” may comprise a degree, mode, and/or nature of activation, as may be appropriate for any particular system.

The first and second calculating and control units 12, 13 may each comprise a computer of a suitable type, a software module, routine, or sub-routine contained in the respective safety module or any other means for the intended purpose. Alternatively, the first and second calculating and control units 12, 13 may form part of the active and passive safety modules 2, 6 respectively.

Functionalities other than the above-mentioned two examples may require additional parallel safety modules, i.e. two or more active and/or passive safety systems may require use of additional active and/or passive safety modules 2, 6.

As will be apparent to person of skill in the art, the disclosed safety system may be modified and altered within the scope of the subsequent claims without departing from the idea and purpose of the invention. The active and passive safety modules 2, 6 as well as the active and passive safety system 4, 8 may operate simultaneously, such that when the collision detector 10 detects a collision and the passive safety system(s) 8 is/are activated, the active safety system 4 affecting e.g. the brakes or the steering equipment may still be activated in order to mitigate the effects of the collision.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for a vehicle comprising:
a remote sensor monitoring a road environment to detect an object and generate a sensor output indicative thereof;
a collision detector detecting a collision with the vehicle and generating a detector output indicative thereof;
an active safety module receiving the sensor output and utilizing a first set of parameters to control operation of an active safety system of the vehicle in a manner providing a first balance between suppression of false positive detections of imminent collision and acknowledgement of true positive detections of imminent collision, the first balance being optimized for control of the active safety system; and
a passive safety module connected in parallel with the active safety module to receive the sensor output and further receiving the detector output, the passive safety module utilizing a second set of parameters to control operation of a passive safety system of the vehicle in a manner providing a second balance having, in relation to the first balance, a relatively lower suppression of false positive detections of imminent collision and a relatively higher acknowledgement of true positive detections of imminent collision.

2. The safety system of claim 1, wherein the first and second sets of parameters comprise respective first and second threshold values for the sensor output adapted to the active safety system and to the passive safety system, respectively.

3. The safety system of claim 1, wherein the first and second sets of parameters comprise respective first and second kinematic models adapted to the active safety system and to the passive safety system, respectively.

4. The safety system of claim 1, wherein the first and second sets of parameters comprise respective first and second parameter intervals within which measurements of properties of the object are allowed, the first and second parameter intervals being adapted to the active safety system and to the passive safety system, respectively.

5. The safety system of claim 1, wherein the remote sensor comprises at least one of a radar sensor, an optical sensor, and a laser sensor.

6. The safety system of claim 1, wherein the collision detector comprises an accelerometer.

7. The safety system of claim 1, further comprising:
a first calculating and control unit operative to, when the active safety module determines that a collision with the object is imminent and activation of the active safety system is warranted, determine an extent of activation of the active safety system and provide a signal indicative thereof to the active safety system; and
a second calculating and control unit operative to, when a collision with the object is imminent and activation of the active safety system is warranted, determine an extent of activation of the passive safety system and provide a signal indicative thereof to the passive safety system.

8. A system for a vehicle comprising:
a remote sensor monitoring a road environment to detect a an object and generate a sensor output indicative thereof;
a collision detector detecting a collision with the vehicle and generating a detector output indicative thereof;
an active safety module receiving the sensor output and utilizing a first set of parameters adapted for optimum function of an active safety system of the vehicle, the first set of parameters comprising at least one of a first sensor output threshold value, a first kinematic model, and a first parameter interval within which measurements of properties of the object are allowed; and
a passive safety module connected in parallel with the active safety module to receive the sensor output and further receiving the detector output, the passive safety module utilizing a second set of parameters adapted for optimum function of a passive safety system of the vehicle, the second set of parameters comprising at least one of a second sensor output threshold value, a second kinematic model, and a second parameter interval within which measurements of properties of the object are allowed.

9. The safety system of claim 8, further comprising:
a first calculating and control unit operative to, when the active safety module determines that a collision with the object is imminent and activation of the active safety system is warranted, determine an extent of activation of the active safety system and provide a signal indicative thereof to the active safety system; and
a second calculating and control unit operative to, when a collision with the object is imminent and activation of the active safety system is warranted, determine an extent of activation of the passive safety system and provide a signal indicative thereof to the passive safety system.

10. The safety system of claim 8, wherein the remote sensor comprises at least one of a radar sensor, an optical sensor, and a laser sensor.

11. The safety system of claim 8, wherein the collision detector comprises an accelerometer.

12. A method for operating a vehicle comprising:
operating a remote sensor to monitor a road environment and generate a sensor output indicative of an object in the environment;
operating a collision detector to generate an output indicative of a collision with the vehicle;
activating an active safety system of the vehicle in response to the remote sensor output utilizing a first set of parameters adapted for optimum function of the active safety system, the first set of parameters comprising at least one of a first sensor output threshold value, a first kinematic model, and a first parameter interval within which measurements of properties of the object are allowed; and
activating a passive safety system of the vehicle in response to the sensor output and the detector output utilizing a second set of parameters adapted for optimum function of the passive safety system, the second set of parameters comprising at least one of a second sensor output threshold value, a second kinematic model, and a second parameter interval within which measurements of properties of the object are allowed.
